(19) United States
(12) Patent Application Publication
(10) Pub. No.: US 2023/0236350 A1
(43) Pub. Date: Jul. 27, 2023

(54) POLYOLEFIN BASED DIFFUSER FOR LIGHTING FIXTURES

(71) Applicant: HAVELLS INDIA LIMITED, New Delhi (IN)

(72) Inventors: Amit KUMAR, New Delhi (IN); Sumant Kumar SANGRAMI, New Delhi (IN); Rishabh JAIN, New Delhi (IN)

(21) Appl. No.: 18/051,701

(22) Filed: Nov. 1, 2022

Related U.S. Application Data
(63) Continuation of application No. PCT/IN2022/050420, filed on May 4, 2022.

(30) Foreign Application Priority Data
Jan. 24, 2022 (IN) 202211003984

(51) Int. Cl. F21V 8/00; C08L 23/06; C08L 23/12; C08L 23/16; C08L 23/20

(52) U.S. Cl. CPC G02B 6/0025; C08L 23/06; C08L 23/12; C08L 23/16; C08L 23/20; C08L 2205/025

(57) ABSTRACT

The present invention provides a novel polyolefin-based polymer diffuser for lighting fixtures. The diffusers comprising 2 polymers in various ratios along with photo-responsive additives, which provide a long lasting and superior product over conventional polycarbonate-based diffusers. The diffusers of the present invention also result in economic advantages in terms of costs and manufacturing.

### CROSS REFERENCE

This application is a continuation of International Application No. PCT/IN2022/050420, filed on May 4, 2022, which claims priority to Indian Patent Application No. 202211003984, filed on Jan. 24, 2022, both of which are herein incorporated by reference in their entirety.

### FIELD OF INVENTION

The present invention relates to the field of lighting technology. In particular, the present invention relates to a diffuser comprising polyolefin-based polymers with superior product and manufacturing characteristics.

### BACKGROUND OF THE INVENTION

Diffusers in lighting fixtures are commonly used to create a diffused lighting effect and to hide the light source(s). Diffusers also serve to scatter the emitted light such that the lighting is softened and is not dazzling (see FIG. 1).

Conventional diffusers are made with transparent plastic material with organic/inorganic additives and UV stabilizers to obtain diffusers with desired lumen output and haze percentage. The transparent plastic material is generally made out of polycarbonate (PC), poly methyl methacrylate (PMMA), polystyrene (PS) and the like, with PC being the preferred choice (see FIG. 2).

However, the cost/productivity of production of diffusers made of PC are not necessarily low or ideal, and there is a need to develop diffusers made of different materials, which are long lasting, provide superior characteristics while at the same time being more cost effective and efficient in production.

### SUMMARY OF THE PRESENT INVENTION

The present invention provides a diffuser for lighting fixtures comprising: (a) a first polyolefin-based polymer; (b) a second polyolefin-based polymer; and (c) at least a photo-responsive additive, wherein weight ratio of the first polymer to the second polymer is in the range of 65:35 to 80:20, and at least a photo-responsive additive is present at a concentration of 50 ppm-400 ppm.

This summary is not intended to identify essential features of the claimed invention nor is it intended for use in determining or limiting the scope of the claimed subject matter.

### BRIEF DESCRIPTION OF THE ACCOMPANYING DRAWINGS

The following drawings form part of the present specification and are included to further illustrate aspects of the present invention. The invention may be better understood by reference to the drawings in combination with the detailed description of the specific embodiments presented herein.

FIG. 1 depicts a diffuser used in lighting applications, in accordance with an embodiment of the present invention.

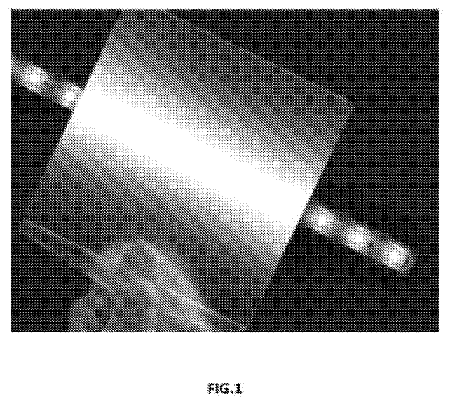

FIG. 2 shows the graphical depiction of conventional diffusers, in accordance with an embodiment of the present invention.

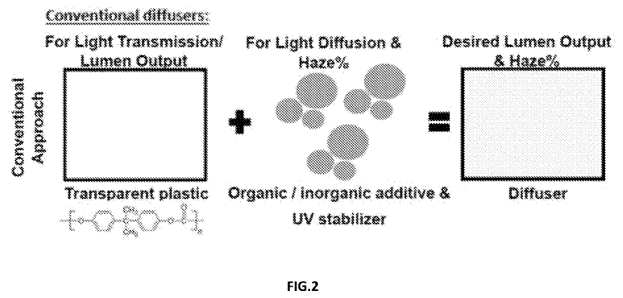

FIG. 3 shows the graphical depiction of the polyolefin-based polymer diffusers, in accordance with an embodiment of the present invention.

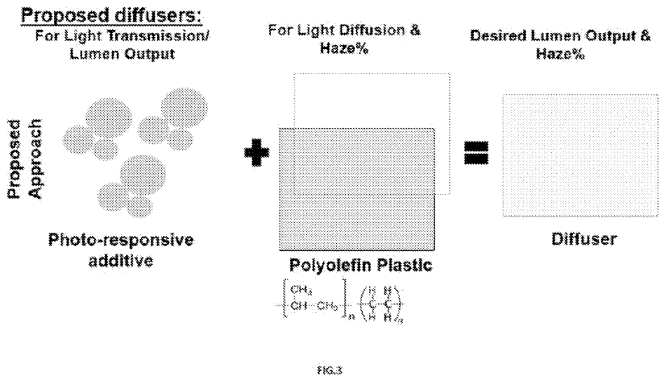

### DETAILED DESCRIPTION OF THE INVENTION

Those skilled in the art will be aware that the invention described herein is subject to variations and modifications other than those specifically described. It is to be understood that the invention described herein includes all such variations and modifications. The invention also includes all such steps, features, and methods referred to or indicated in this specification, individually or collectively, and any and all combinations of any two or more of said steps or features.

For convenience, before further description of the present invention, certain terms employed in the specification, examples are collected here. These definitions should be read in light of the remainder of the disclosure and understood as by a person of skill in the art. Unless defined otherwise, all technical and scientific terms used herein have the same meaning as commonly understood by a person of ordinary skill in the art. The terms used throughout this specification are defined as follows, unless otherwise limited in specific instances.

As used in the specification and the claims, the singular forms “a”, “an”, and “the” include plural referents unless the context dearly dictates otherwise.

The present disclosure is not to be limited in scope by the specific embodiments described herein, which are intended for the purposes of exemplification only.

Functionally-equivalent processes and methods are clearly within the scope of the disclosure, as described herein.

There is provided a diffuser for lighting fixtures comprising: (a) a first polyolefin-based polymer; (b) a second polyolefin-based polymer; and (c) at least a photo-responsive additive, wherein weight ratio of the first polymer to the second polymer is in the range of 65:35 to 80:20, and at least a photo-responsive additive is present at a concentration of 50 ppm-400 ppm.

The at least a photo-responsive additive comprises bis(benzoxazole) framework as shown below.

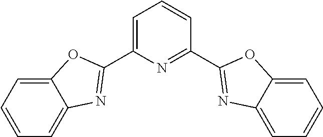 [SMILES: c1cc(-c2nc3ccccc3o2)nc(-c2nc3ccccc3o2)c1]

The photo-responsive additive is selected from the group consisting of bis-benzoxazolyl-stilbene and bis-benzoxazolyl-thiophene, benzotriazole-phenylcoumarins, naphtotriazole-phenylcoumarins, triazine-phenylcoumarins and bis(styryl)biphenyls. It is understood by a person skilled in the art that particular photo-responsive additives comprising bis(benzoxazole) framework can be used in the present invention.

In an embodiment, the polyolefin-based polymer used in the diffuser of the present invention is selected from the group consisting of ethylene-propylene random copolymer with 5-15% ethylene content, ethylene-propylene impact copolymer with 40-70% ethylene content, polybutylene, cyclic olefin copolymer (COC), polypropylene-1-hexene-copolymer, polypropylene random copolymer, and combinations thereof.

In a preferred embodiment, the first polyolefin-based polymer is ethylene-propylene random copolymer with 5-15% ethylene content and second polyolefin-based polymer is ethylenepropylene impact copolymer with 40-70% ethylene content. The ratio of first polymer to second polymer is 70:30. The concentration of photo-responsive additive is in the range of 50-400 ppm. In a preferred embodiment, the photo-responsive additive concentration is 50 ppm, 100 ppm, 200 ppm, or 400 ppm. In a preferred embodiment, the photo-responsive additive is 2,2 (2,5 thiophenediyl) bis 5 (1,1 dimethylethyl) benzoxazole.

In another preferred embodiment, the first polyolefin-based polymer is polybutylene and second polyolefin-based polymer is cyclic olefin copolymer (COC). The ratio of first polymer to second polymer is 70:30. The concentration of photo-responsive additive is in the range of 50-150 ppm. In a preferred embodiment, the photo-responsive additive concentration is 100 ppm. In a preferred embodiment, the photo-responsive additive is 2,5-thiophenedlylbis(5-tert-butyl-1,3-benzoxazole).

In yet another preferred embodiment, the first polyolefin-based polymer is polypropylene-1-hexene-copolymer, and second polyolefin-based polymer is polypropylene random copolymer. The ratio of first polymer to second polymer is 65:25. The concentration of photo-responsive additive is in the range of 50-150 ppm. In a preferred embodiment, the photo-responsive additive concentration is 100 ppm. In a preferred embodiment, the photo-responsive additive is 4,4-Bis(2-benzoxazolyl) stilbene.

The diffusers of the present invention comprising polyolefin-based polymers can be manufactured by known methods, which are within the expertise of a person skilled in the art, in a similar manner as that for manufacturing PC based diffusers.

### EXAMPLES

The disclosure will now be illustrated with working examples, which is intended to illustrate the working of disclosure and not intended to take restrictively to imply any limitations on the scope of the present disclosure. Unless defined otherwise, all technical and scientific terms used herein have the same meaning as commonly understood to one of ordinary skill in the art to which this disclosure belongs.

### Example 1

Ethylene-propylene random copolymer with 5-15% ethylene content was selected as the first polyolefin-based polymer (PP1) and ethylene-propylene impact copolymer with 40-70% ethylene content was selected as the second polyolefin-based polymer (PP2). The first and the second polymer were combined in various ratios. For the ratios tested 20:80, 30:70, 40:60, 50:50, and 60:40, in each case, the LED was visible, suggesting that the particular combination of the polymers at the aforementioned ratio were not suitable as diffusers for lighting fixtures. As a comparison, polycarbonate (PC) diffuser was used. In each case, the haze percentage was also below the haze percentage for PC diffuser (see Table 1 below), indicating that the particular combination at the said ratios is not suitable as a diffuser.

TABLE 1

| | Haze | Luminous | | Radiant |
|---|---|---|---|---|
| Diffuser | % age | efficacy (%) | LED | power (W) |
| PC | 98.1 | 78.9 | Not | 2.59 |
| | | | visible | |
| PP1:PP2 (20:80) | 89.47 | 81.96 | Visible | 2.68 |
| PP1:PP2 (30:70) | 92.13 | 81.32 | Visible | 2.67 |
| PP1:PP2 (40:60) | 94.65 | 80.11 | Visible | 2.64 |
| PP1:PP2 (50:50) | 96.21 | 79.46 | Visible | 2.62 |
| PP1:PP2 (60:40) | 97 | 77.02 | Visible | 2.52 |

Surprisingly, it was found that diffuser comprising PP1:PP2 at a ratio of 70:30 was comparable to PC diffuser in that LED was not visible. However, both luminous efficacy and radiant power were lower than that of PC (see Table 2 below).

TABLE 2

| | Haze | Luminous | | Radiant |
|---|---|---|---|---|
| Diffuser | % age | efficacy (%) | LED | power (W) |
| PC | 98.1 | 78.9 | Not | 2.59 |
| | | | visible | |
| PP1:PP2 (70:30) | 98.3 | 76.41 | Not | 2.55 |
| | | | visible | |

Keeping the ratio of PP1 to PP2 at 70:30, photo-responsive additive was added at various concentrations in order to enhance the characteristics of the diffuser and to make it more suitable as a superior alternative to PC diffuser.

As seen in Table 3 below, additive (2,2 (2,5 thiophenediyl) bis 5 (1,1 dimethylethyl) benzoxazole) was added at various concentrations 50 ppm, 100 ppm, 200 ppm and 400 ppm. In the case where the additive concentration is 100 ppm, it was observed that while the haze percentage and luminous efficacy was comparable to PC, there was a marked enhancement in radiant power, which is indicative of the fact that this particular diffuser is a better alternative to conventional PC diffusers.

TABLE 3

| | Haze | Luminous | | Radiant |
|---|---|---|---|---|
| Diffuser | % age | efficacy (%) | LED | power (W) |
| PC | 98.1 | 78.9 | Not | 2.59 |
| | | | visible | |
| PP1:PP2 (70:30) + | 98.3 | 77.58 | Not | 2.43 |
| 50 ppm | | | visible | |
| PP1:PP2 (70:30) + | 98.3 | 79.14 | Not | 2.6 |
| 100 ppm | | | visible | |
| PP1:PP2 (70:30) + | 98.3 | 78.87 | Not | 2.53 |
| 200 ppm | | | visible | |
| PP1:PP2 (70:30) + | 98.4 | 74.27 | Not | 2.47 |
| 50 ppm | | | visible | |

The accelerated UV performance of the polyolefin-based polymer diffusers of the present invention was also tested against the conventional PC diffusers. As seen in Table 4 below, the diffusers of the present invention exhibit significantly lower yellowing and color fading.

TABLE 4
(UVC exposure with irradiance of 236.68 μW/cm²)

| Diffuser | Δb (yellowing) | ΔE (color fading) |
|---|---|---|
| PC (after 54 hours) | 6.2 | 6.79 |
| Present invention (54 hours) | 0.93 | 1.09 |

There is also a significant improvement in various production parameters, including cost of the polyolefin-based polymer diffusers, energy saving, manufacturing time of the present invention as compared to PC diffusers (see Table 5 below).

TABLE 5

| Parameter | PC | Polyolefin |
|---|---|---|
| Energy saving: lower | 280-320° C. | 180-220° C. |
| processing temperature | | |
| Lean manufacturing: | Pre-drying at 120° C. | No pre-drying |
| Processing step reduction | for 3-4 hours | |
| Productivity: Cycle | — | 15% less |
| time reduction | | |
| Less raw material | 1 kg (1.2 g/cc) | 0.75 kg (0.9 g/cc) |
| consumption | | |
| Less raw material price | Rs. 300 | Rs. 150 |

| | |
|---|---|
| Cost saving per kg of | 62.5% |
| raw material | |

These data clearly show that apart from superior product characteristics of the polyolefin-based polymer diffusers of the present invention over conventional PC diffusers, there is also a significant advantage in the manufacturing of the diffusers of the present invention using polyolefin-based polymers as compared to PC.

### Example 2

Similar to Example 1, in Example 2, Polybutylene was selected as the first polyolefin-based polymer and cyclic olefin copolymer (COC) was selected as the second polyolefin-based polymer. Of various ratios of first to second polymer tested (data not shown), the particular ratio of 80:20 was selected for further analysis as it showed acceptable superior characteristics. Additive in the form of 2,5-thiophenedlylbis(5-tert-butyl-1,3-benzoxazole) was added at concentration of 50, 100, and 150 ppm. It was observed that additive at the concentration of 100 ppm gave the best results as shown in Table 6 below.

TABLE 6

| | Haze | Luminous | | Radiant |
|---|---|---|---|---|
| Diffuser | % age | efficacy (%) | LED | power (W) |
| PC | 98.1 | 78.9 | Not | 2.59 |
| | | | visible | |
| Polybutlene:COC | 98.2 | 74.78 | Not | 2.61 |
| (80:20) + 100 ppm | | | visible | |

### Example 3

Similar to Example 1, in Example 3, polypropylene-1-hexene-copolymer was selected as the first polyolefin-based polymer and polypropylene random copolymer was selected as the second polyolefin-based polymer. Of various ratios of first to second polymer tested (data not shown), the particular ratio of 65:35 was selected for further analysis as it showed acceptable superior characteristics. Additive in the form of 4,4-Bis(2-benzoxazolyl) stilbene was added at concentration of 50, 100, and 150 ppm. It was observed that additive at the concentration of 100 ppm gave the best results as shown in Table 7 below.

TABLE 7

| | Haze | Luminous | | Radiant |
|---|---|---|---|---|
| Diffuser | % age | efficacy (%) | LED | power (W) |
| PC | 98.1 | 78.9 | Not | 2.59 |
| | | | visible | |
| polypropylene-1-hexene- | 97.8 | 74.8 | Not | 2.6 |
| copolymer:polypropylene | | | visible | |
| random copolymer | | | | |
| (65:35) + 100 ppm | | | | |

Overall, it can be appreciated from the present disclosure that diffusers made of polyolefin-based polymers offer a superior alternative to conventional PC based diffusers. The diffusers of the present invention are long lasting, do not show UV degradation, are significantly economical to produce, and also show comparable-superior characteristics that the PC diffusers known in the art.

I/we claim:

1. A diffuser for lighting fixtures comprising: (a) a first polyolefin-based polymer; (b) a second polyolefin-based polymer; and (c) at least a photo-responsive additive, wherein weight ratio of the first polymer to the second polymer is in the range of 65:35 to 80:20, and at least a photo-responsive additive is present at a concentration of 50 ppm-400 ppm.

2. The diffuser as claimed in claim 1, wherein said at least a photo-responsive additive is selected from the group consisting of bis-benzoxazolyl-stilbene and bis-benzoxazolyl-thiophene, benzotriazole-phenylcoumarins, naphtotriazole-phenylcoumarins, triazine-phenylcoumarins and bis(styryl)biphenyls.

3. The diffuser as claimed in claim 1, wherein said first and second polyolefin-based polymer is selected from the group consisting of ethylene-propylene random copolymer with 5-15% ethylene content, ethylene-propylene impact copolymer with 40-70% ethylene content, polybutylene, cyclic olefin copolymer (COC), polypropylene-1-hexene-copolymer, polypropylene random copolymer, and combinations thereof.

4. The diffuser as claimed in claim 3, wherein said first polyolefin-based polymer is ethylene-propylene random copolymer with 5-15% ethylene content; said second polyolefin-based polymer is ethylene-propylene impact copolymer with 40-70% ethylene content; said ratio between first and second polymer is 70:30; and said photo-responsive additive concentration is in the range of 50-400 ppm.

5. The diffuser as claimed in claim 4, wherein the photo-responsive additive is 2,2 (2,5 thiophenediyl) bis 5 (1,1 dimethylethyl) benzoxazole at a concentration of 50, 100, 200, or 400 ppm.

6. The diffuser as claimed in claim 3, wherein said first polyolefin-based polymer is polybutylene; said second polyolefin-based polymer is cyclic olefin copolymer (COC), said ratio between first and second polymer is 80:20; and said photo-responsive additive concentration is in the range of 50-150 ppm.

7. The diffuser as claimed in claim 6, wherein the photo-responsive additive is 2,5-thiophenedlylbis(5-tert-butyl-1,3-benzoxazole) at a concentration of 100 ppm.

8. The diffuser as claimed in claim 3, wherein said first polyolefin-based polymer is polypropylene-1-hexene-copolymer; said second polyolefin-based polymer is polypropylene random copolymer; said ratio between first and second polymer is 65:25; and said photo-responsive additive concentration is in the range of 50-150 ppm.

9. The diffuser as claimed in claim 8, wherein the photo-responsive additive is 4,4-Bis(2-benzoxazolyl) stilbene at a concentration of 100 ppm.

10. The diffuser as claimed in claim 1, wherein the luminous efficacy is in the range of 75-85%, haze percentage is in the range of 97-99%.
